(19) United States
(12) Patent Application Publication
(10) Pub. No.: US 2025/0233488 A1
(43) Pub. Date: Jul. 17, 2025

(54) MOTOR

(71) Applicant: NIDEC CORPORATION, Kyoto (JP)

(72) Inventors: Shinji SHIMODAIRA, Kyoto (JP); Masahiro SHIRAISHI, Kyoto (JP)

(21) Appl. No.: 19/010,459

(22) Filed: Jan. 6, 2025

(30) Foreign Application Priority Data
Jan. 11, 2024 (JP) 2024-002846

(51) Int. Cl. H02K 11/01; H02K 1/18

(52) U.S. Cl. CPC H02K 11/014; H02K 1/187; H02K 2211/03

(57) ABSTRACT

A motor includes a stator, a rotor, a stator holder with electrical conductivity that holds the stator, a circuit board, and a fastening screw. The fastening screw with electrical conductivity includes a head portion and a screw body, and holds the circuit board clamped between the head portion and the stator holder in a state where the screw body is screwed to the stator holder while being in contact with both a frame ground portion of the circuit board and the stator holder.

### CROSS-REFERENCE TO RELATED APPLICATIONS

The present application claims priority under 35 U.S.C. § 119 to Japanese Patent Application No. 2024-002846, filed on Jan. 11, 2024, the entire contents of which are hereby incorporated herein by reference.

### 1. FIELD OF THE INVENTION

The present disclosure relates to motors.

### 2. BACKGROUND

Using a pin as a method for fixing a circuit board to a stationary part of a motor has been conventionally known. For example, a circuit board is conventionally fixed to an insulating part of a stator by a plurality of connection pins.

Unfortunately, when the circuit board is connected to the stationary part of the motor by the connection pins, connection strength may be conventionally insufficient. Although increasing fixing strength by soldering the connection pin to the circuit board is conceivable for this problem, a working process becomes complicated.

### SUMMARY

An example embodiment of a motor according to the present disclosure includes a stator including a plurality of coil portions arranged along a circumferential direction, a rotor to cover a radially outer side of the stator and rotatable about a central axis extending in an axial direction, a stator holder with electrical conductivity including a tubular portion including an outer peripheral surface in contact with an inner peripheral surface of the stator, a base portion extending radially outward from a lower portion of the tubular portion, and an outer wall extending downward from an outer portion of the base portion, a circuit board fixed to the stator holder, and a fastening screw with electrical conductivity including a head portion and a screw body, the fastening screw not only holding the circuit board sandwiched between the head portion and the stator holder while the screw body is screwed to the stator holder, but also being in contact with both a frame ground portion of the circuit board and the stator holder.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a sectional view schematically illustrating a motor according to an example embodiment of the present disclosure.

FIG. 2 is a diagram when FIG. 1 is viewed from an A-A direction.

FIG. 3 is a plan view of a circuit board according to an example embodiment of the present disclosure.

FIG. 4 is a bottom view of the circuit board.

FIG. 5 is an enlarged view of the vicinity of a fastening screw in FIG. 1, while not illustrating a power cable portion.

### DETAILED DESCRIPTION

Example embodiments of the present disclosure will be described below with reference to the drawings.

First, a motor 1 herein has a rotation axis that is referred to as a central axis CA, and a direction parallel to the central axis CA is referred to as an “axial direction”. Then, one axial direction from a lower bearing 8 toward an upper bearing 7 is referred to as “axially upward”, and the other axial direction from the upper bearing 7 toward the lower bearing 8 is referred to as “axially downward”. Each of components includes surfaces in which a surface facing axially upward is referred to as “upper surface”, and a surface facing axially downward is referred to as a “lower surface”. Each of the components also includes end parts in which an end in the axially direction is referred to as an “axial end part”, the axial end part being at a position that is referred to as an “axial end”. In particular, an end part axially upward is referred to as an “axial upper end part”, and a position of the end part axially upward is referred to as an “axial upper end”. Additionally, an end part axially downward is referred to as an “axial lower end part”, and a position of the end part axially downward is referred to as an “axial lower end”.

Then, a direction in which a straight line orthogonal to the central axis CA extends is referred as a “radial direction”. One side in the radial direction toward the central axis CA is referred to as “radially inward”, and another side in the radial direction away from the central axis CA is referred to as “radially outward”. Each of the components also includes side surfaces in which a side surface facing the radial direction is referred to as a “radial side surface”. In particular, a side surface facing radially inward is referred to as a “radially inward surface”, and a side surface facing radially outward is referred to as a “radially outward surface”. Each of the components also includes an end part in the radial direction that is referred to as a “radial end part”, and a position of the end part in the radial direction is referred to as a “radial end”. In particular, an end part radially inward is referred to as “radially inward end part”, and a position of the end part radially inward is referred to as a “radially inward end”. Additionally, an end part radially outward is referred to as “radially outward end part”, and a position of the end part radially outward is referred to as a “radially outward end”.

Then, a rotation direction about the central axis CA is referred to as a “circumferential direction”. In the circumferential direction, a counterclockwise direction with respect to the central axis CA when viewed from axially upward is referred to as “one circumferential direction”, and a clockwise direction with respect to the central axis CA when viewed from axially upward is referred to as “another circumferential direction”. Each of the components includes the side surfaces in which a side surface facing the circumferential direction is referred to as a “circumferential side surface”. Each of the components also includes an end part in the circumferential direction that is referred to as a “circumferential end part”, and a position of end part in the circumferential direction is referred to as a “circumferential end”. In particular, an end part in the one circumferential direction is referred to as “one circumferential end part”, and a position of the end part in the one circumferential direction is referred to as “one circumferential end”. Additionally, an end part in the other circumferential direction is referred to as “another circumferential end part”, and a position of the end part in the other circumferential direction is referred to as “another circumferential end”.

Each of names of the directions, the surfaces, the end parts, and their positions described above does not indicate a positional relationship, a direction, or the like in a state being incorporated into an actual device. Hereinafter, an example embodiment will be described with reference to the drawings.

The motor 1 is a brushless motor using alternating current of three phases including a U-phase, a V-phase, and a W-phase as drive current. The motor 1 according to the present example embodiment is a so-called outer-rotor motor in which a rotor rotates outside a stator.

The motor 1 described below can be applied to any device as long as the device can be applied with a motor.

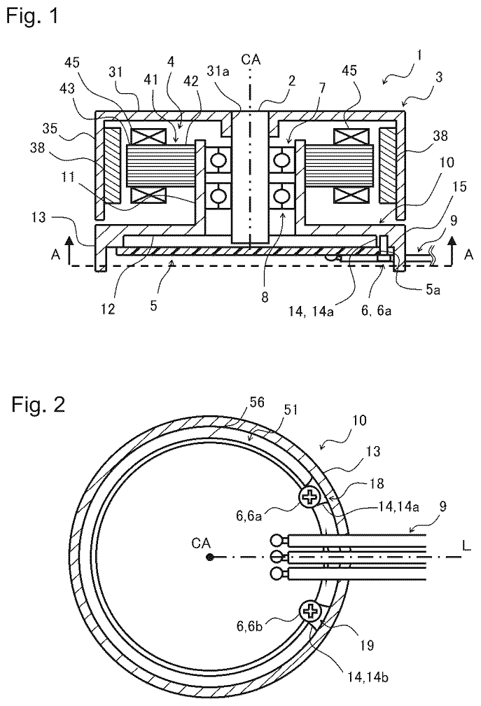

FIG. 1 is a sectional view schematically illustrating the motor 1 according to the example embodiment. As illustrated in FIG. 1, the motor 1 includes a shaft 2, a rotor 3, a stator 4, a bracket 10 (stator holder), and a circuit board 5.

The shaft 2 is a round bar-shaped member extending in the axial direction along the central axis CA, and is rotatable together with the rotor 3 about the central axis CA. That is, the shaft 2 is a rotation shaft of the motor 1. The shaft 2 is rotatably supported by the upper bearing 7 and the lower bearing 8 with respect to the bracket 10. Although the upper bearing 7 and the lower bearing 8 are ball bearings in the present example embodiment, they are not limited to this and may be other types of bearing.

The rotor 3 is provided covering a radially outer side of the stator 4, and is rotatable about the central axis CA extending in the axial direction. The rotor 3 is fixed to the shaft 2 by screwing or the like. As illustrated in FIG. 1, the rotor 3 includes an upper wall 31, a peripheral wall 35, and a plurality of magnets 38.

The upper wall 31 is formed in a substantially circular shape when viewed from above in the axial direction. The upper wall 31 is provided in its center part with a through-hole 31a, and the shaft 2 is fixed to the through-hole 31a while being inserted thereinto.

The peripheral wall 35 is formed in a cylindrical shape extending downward from an outer peripheral edge portion of the upper wall 31. The peripheral wall 35 is formed of a ferromagnet, for example. Although FIG. 1 shows an example in which the upper wall 31 and the peripheral wall 35 are integrally formed of a single member, the present disclosure is not limited thereto, and the upper wall 31 and the peripheral wall 35 may be formed of separate members and fixed to each other with an adhesive or the like.

Each of the plurality of magnets 38 is formed in a substantially rectangular parallelepiped shape having a predetermined thickness. The plurality of magnets 38 is arranged in a substantially cylindrical shape along the circumferential direction. The plurality of magnets 38 is fixed to an inner peripheral surface of the peripheral wall 35 such that different magnetic poles (i.e., an S-pole and an N-pole) face radially inward alternately in the circumferential direction. For example, the magnets 38 are each fixed to the peripheral wall 35 with an adhesive.

The stator 4 is provided inside the rotor 3. More specifically, the stator 4 is provided radially inward from a part surrounded by the plurality of magnets 38 fixed to the rotor 3. The stator 4 includes a stator core 41 and a plurality of coil portions 45.

The stator core 41 is disposed radially inside the rotor 3. In the present example embodiment, the stator core 41 is formed by stacking electromagnetic steel plates in the axial direction, the electromagnetic steel plates each having a thickness in the axial direction. The stator core 41 includes a core back 42 in an annular shape and a plurality of teeth 43 protruding radially outward from an outer peripheral surface of the core back 42. The plurality of teeth 43 is arranged at equal intervals in the circumferential direction.

The plurality of coil portions 45 is arranged along the circumferential direction. Each of the plurality of coil portions 45 is formed by winding a coil wire around corresponding one of the teeth 43. The plurality of coil portions 45 include a U-phase coil part through which a U-phase current flows, a V-phase coil part through which a V-phase current flows, and a W-phase coil part through which a W-phase current flows (all not illustrated).

The motor 1 according to the present example embodiment includes the rotor 3 that is rotated using a rotating magnetic field generated by the U-phase, V-phase, and W-phase currents flowing through the corresponding coil portions 45 through a power cable portion 9 connected to the circuit board 5.

The bracket 10 is a part of the motor 1, the part holding the stator 4. The bracket 10 includes a tubular portion 11, a base portion 12, an outer wall 13, and a fastened portion 14, which are integrally formed by a single member. The bracket 10 is formed of a metal member (e.g., a magnesium alloy).

The tubular portion 11 is a wall in a cylindrical shape disposed with its central axis coaxial with the central axis CA. The tubular portion 11 has an outer peripheral surface in contact with an inner peripheral surface of the stator 4. The tubular portion 11 has an inner peripheral surface with an axially upper part in which an outer ring of the upper bearing 7 is held and with an axially lower portion in which an outer ring of the lower bearing 8 is held. As a result, the shaft 2 to which the inner ring of the upper bearing 7 and the inner ring of the lower bearing 8 are fixed is rotatably held with respect to the tubular portion 11.

The base portion 12 is a plate-like part formed annularly extending radially outward from a lower portion of the tubular portion 11 while having a thickness in an up-down direction. The base portion 12 includes a radially outer end part that is formed overlapping a radially outer end part of the peripheral wall 35 of the rotor 3 over the entire circumference when viewed from the axial direction. Between an upper end surface of the base portion 12 and a lower end part of the peripheral wall 35 of the rotor 3, a slight gap is formed in the axial direction. This gap prevents the peripheral wall 35 from being rubbed against the base portion 12 during rotation of the rotor 3. Depending on application of the motor 1, a seal member or the like may be provided in a part of the gap to improve waterproof performance.

The outer wall 13 is a cylindrical part formed extending downward from an outer portion of the base portion 12. The outer wall 13 internally accommodates the circuit board 5. Although an opening part on a lower side of the outer wall 13 is exposed in the present example embodiment, the present disclosure is not limited thereto. Specifically, the opening part may be covered with a disk-shaped cover (not illustrated). This cover prevents the circuit board 5 from being exposed to the outside.

The fastened portion 14 is formed in a substantially columnar shape, and is integrated with the base portion 12 and the outer wall 13. The fastened portion 14 includes an upper end part integrated with the base portion 12, and a side surface integrated with the outer wall 13. The fastened portion 14 includes a lower end surface 15 formed in a flat shape.

FIG. 2 is a diagram when FIG. 1 is viewed from an A-A direction. The motor 1 according to the present example embodiment includes a first fastened portion 14a and a second fastened portion 14b. That is, the motor 1 includes the two fastened portions 14a and 14b.

In the present example embodiment, the first fastened portion 14a and the second fastened portion 14b are provided holding the power cable portion 9. Specifically, when a half line extending from the central axis CA as a reference point in a direction in which the power cable portion 9 extends is defined as a reference line L with reference to FIG. 2, the first fastened portion 14a is provided at a position of 30 degrees counterclockwise from the reference line L about the reference point. The second fastened portion 14b is provided at a position of 30 degrees clockwise from the reference line L about the reference point.

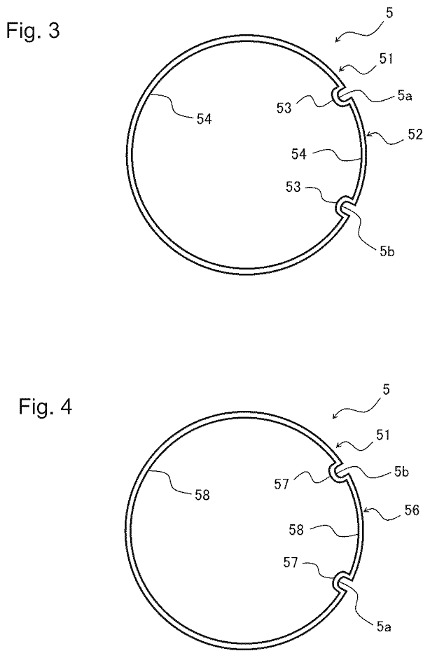

FIG. 3 is a plan view of the circuit board 5. FIG. 4 is a bottom view of the circuit board 5. The circuit board 5 is a plate-like member having a circular outer shape, and includes a front surface and a back surface each of which is equipped with various components (not illustrated). The circuit board 5 is fixed to the fastened portion 14 of the bracket 10.

The circuit board 5 is housed inside the bracket 10. Specifically, an outer peripheral edge portion of the circuit board 5 is covered with an inner peripheral surface of an outer wall of the bracket 10 from radially outward. This configuration prevents the circuit board 5 from being exposed to the outside of the motor 1.

The outer peripheral edge portion of the circuit board 5 is provided with a first cutout 5a and a second cutout 5b. That is, the circuit board 5 is provided with two cutouts. Each of the cutouts 5a and 5b is formed in a substantially semicircular arc shape when viewed from the axial direction.

With reference to FIG. 1, the first cutout 5a is provided at a position overlapping the first fastened portion 14a when viewed from the axial direction. Similarly, although not illustrated, the second cutout 5b is provided at a position overlapping the second fastened portion 14b when viewed from the axial direction.

With reference to FIGS. 2 to 4, the circuit board 5 is provided with a frame ground portion 51. When the circuit board 5 is fixed to the bracket 10 using a fastening screw 6 in the motor 1, the frame ground portion 51 is electrically connected to the bracket 10 as described in detail below. As a result, the circuit board 5 accommodated in the bracket 10 is shielded by the bracket 10, so that electromagnetic noise generated from electronic components mounted on the circuit board 5 can be prevented from leaking to the outside of the motor 1. The frame ground portion 51 is electrically connected to a signal ground (not illustrated) through a predetermined electronic component (a resistor, a capacitor, etc.), for example.

The frame ground portion 51 includes an upper frame ground plane 52 (first frame ground plane) and a lower frame ground plane 56 (second frame ground plane). With reference to FIG. 3, the upper frame ground plane 52 is a conductive pattern defined on an upper surface of the circuit board 5, and is defined on the surface on a side opposing the base portion 12. The lower frame ground plane 56 is a conductive pattern defined on a lower surface of the circuit board 5, and is defined on the surface opposite to the surface provided with the upper frame ground plane. The upper frame ground plane 52 and the lower frame ground plane 56 are electrically connected to each other using a through-hole (not illustrated).

With reference to FIG. 3, the upper frame ground plane 52 is formed in an annular shape on an outer peripheral part of the upper surface of the circuit board 5. Specifically, the upper frame ground plane 52 includes an arc part 53 formed in an arc shape near each of the cutouts 5a and 5b, and a connecting part 54 connecting the arc parts to each other. The upper frame ground plane 52 is formed of a conductive member such as a member made of copper, and has a surface plated with gold. The upper frame ground plane 52 is not covered with a resist and is exposed to the outside.

With reference to FIG. 4, the lower frame ground plane 56 is formed in an annular shape on an outer peripheral part of the lower surface of the circuit board 5. Specifically, the lower frame ground plane 56 includes an arc part 57 formed in an arc shape near each of the cutouts 5a and 5b, and a connecting part 58 connecting the arc parts to each other. The lower frame ground plane 56 has a shape overlapping the upper frame ground plane 52 when viewed from the axial direction. The lower frame ground plane 56 is formed of a conductive member such as a member made of copper, and has a surface plated with gold, as with the upper frame ground plane 52. The lower frame ground plane 56 is not covered with a resist and is exposed to the outside.

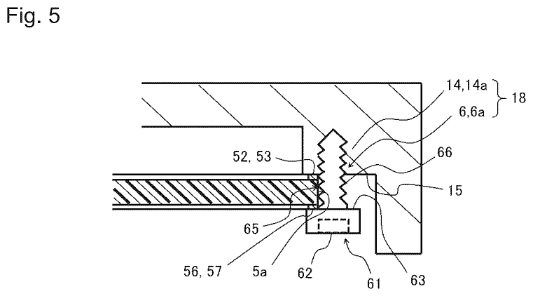

FIG. 5 is an enlarged view of the vicinity of the fastening screw 6 in FIG. 1, while not illustrating the power cable portion 9. The fastening screw 6 is a member for fastening the circuit board 5 to the bracket 10. The motor 1 according to the present example embodiment includes a first fastening screw 6a and a second fastening screw 6b. That is, the motor 1 includes the two fastening screws 6a and 6b. Hereinafter, when each fastening screw is described without being distinguished, the fastening screw is designated by 6, and when the fastening screws are described while being distinguished, the fastening screws are designated by 6a and 6b.

The fastening screw 6 includes a head portion 61 and a screw body 65, which are integrally formed of a single member. The fastening screw 6 is a self-tapping screw, for example. The fastening screw 6 is formed of a conductive member such as a member made of iron or stainless steel.

The head portion 61 is formed in a substantially columnar shape having a thickness in the up-down direction. The head portion 61 has a surface on one side, the surface being provided with a screw hole 62 for fastening a screw. The head portion 61 has a surface on another side, the surface being provided integrally with the screw body 65 extending in a direction away from the surface. The surface on the other side of the head portion 61, i.e., the surface of the head portion 61 close to the screw body 65, is formed as a flat surface 63 that is flat in a horizontal direction with respect to the direction in which the screw body 65 extends.

The screw body 65 has a smaller outer shape and is longer in the axial direction than the head portion 61, and is provided on its outer peripheral surface with a spiral screw part 66. The screw body 65 is screwed to the fastened portion 14.

With reference to FIG. 2, the fastening screws 6a and 6b are provided at positions overlapping the fastened portions 14a and 14b, respectively, when viewed from the axial direction. Specifically, when viewed from the axial direction, the first fastening screw 6a is provided at the position overlapping the first fastened portion 14a, and the second fastening screw 6b is provided at the position overlapping the second fastened portion 14b.

The fastening screws 6a and 6b fix the circuit board 5 to the bracket 10 together with the corresponding fastened portions 14a and 14b. Specifically, each of the fastening screws 6a and 6b holds the circuit board 5 clamped between the head portion 61 and corresponding one of the fastened portions 14a and 14b while the screw body 65 is screwed to the corresponding one of the fastened portions 14a and 14b of the bracket 10. The fastening screws 6a and 6b are fastened and fixed to the corresponding fastened portions 14a and 14b while being disposed inside the corresponding cutouts 5a and 5b of the circuit board 5. That is, the fastening screw 6a and the fastened portion 14a function as a first fixing mechanism 18 that holds a part of the circuit board 5 around the cutout clamping the part in the up-down direction. Additionally, the fastening screw 6b and the fastened portion 14b function as a second fixing mechanism 19 that holds a part of the circuit board 5 around the cutout 5b while clamping the part in the up-down direction. That is, the circuit board 5 is fixed to the bracket 10 using these fixing mechanisms 18 and 19.

In this state, the flat surface 63 of the head portion 61 of the fastening screw 6a is in surface contact with the arc part 57 of the lower frame ground plane 56 with reference to FIG. 5. As a result, both the flat surface 63 and the arc part 57 can be brought into contact with each other over a wide range, so that the frame ground can be electrically stabilized. Similarly, although not illustrated, the flat surface 63 of the head portion 61 of the fastening screw 6b is also in surface contact with the arc part 57 of the lower frame ground plane 56.

In this state, the arc part 53 of the upper frame ground plane 52 is in surface contact with the lower end surface 15 of the fastened portion 14a. As a result, both the flat surface 63 and the arc part 57 can be brought into contact with each other over a wide range, so that the frame ground can be electrically stabilized. Similarly, although not illustrated, the arc part 53 of the upper frame ground plane 52 is in surface contact with the lower end surface 15 of the fastened portion 14b. That is, the fastening screws 6a and 6b are in contact with both the frame ground portion 51 of the circuit board 5 and the bracket 10.

In this state, the first fixing mechanism 18 is provided counterclockwise from the power cable portion 9 about the central axis CA as viewed in the axial direction, and the second fixing mechanism 19 is provided clockwise from the power cable portion 9 about the central axis CA as viewed in the axial direction, with reference to FIG. 2. That is, the power cable portion 9 is provided between the two fixing mechanisms 18 and 19. As a result, even when downward force is applied to the power cable portion 9, for example, deformation of the circuit board 5 can be suppressed by the two fixing mechanisms 18 and 19.

As described above, the circuit board 5 is fixed to the bracket 10 using the fastening screws 6 in the present example embodiment. Thus, the circuit board 5 can be firmly fixed to the bracket 10. That is, the present example embodiment enables providing a motor excellent in durability without performing complicated work.

In the present example embodiment, the frame ground portion 51 can be electrically connected to the bracket 10 in a state where the circuit board 5 is fixed to the fastened portion 14 of the bracket 10 using the fastening screw 6 having conductivity. As a result, the electronic components mounted on the circuit board 5 are shielded while being covered with the outer wall 13 of the bracket 10, so that the electromagnetic noise generated from the circuit board 5 can be prevented from leaking to the outside of the bracket 10.

In the present example embodiment, the circuit board 5 is fixed to the bracket 10, and frame ground for preventing electromagnetic noise from the circuit board 5 from leaking to the outside is achieved by screwing with the fastening screw 6. That is, the present example embodiment enables achieving simultaneously both fixing of the circuit board and prevention of leakage of electromagnetic noise by a simple method of screwing.

In the present example embodiment, the circuit board 5 can be fixed to the bracket 10 using the fixing mechanisms 18 and 19 including the respective fastened portions 14 provided integrally with at least one of the base portion 12 and the outer wall 13, and the fastening screws 6.

Although the motor including the two fixing mechanisms 18 and 19 has been described as an example in the above example embodiment, the present disclosure is not limited thereto, and the number of fixing mechanisms may be one, or three or more.

Although the upper frame ground plane 52 and the lower frame ground plane 56 are provided as the frame ground portion 51 while the upper frame ground plane 52 is in contact with the bracket 10 and the lower frame ground plane 56 is in contact with the fastening screw 6 in the above example embodiment, the present disclosure is not limited thereto. Specifically, the fastening screw 6 may have any configuration as long as the fastening screw 6 is in contact with the frame ground portion 51 and the bracket 10. For example, the upper frame ground plane 52 may be eliminated in the example embodiment described above.

The example embodiment of the present disclosure have been described above. The scope of the present disclosure is not limited to the example embodiment described above. The present disclosure can be implemented by making various modifications to the example embodiment described above without departing from the gist of the disclosure. Additionally, the matters described in the example embodiment described above are arbitrarily combined together as appropriate within a range where no inconsistency occurs.

Hereinafter, the example embodiment described above will be described comprehensively below.

A motor has a configuration (first configuration) including: a stator including a plurality of coil portions arranged along a circumferential direction; a rotor provided so as to cover a radially outer side of the stator and rotatable about a central axis extending in an axial direction; a stator holder with electrical conductivity including a tubular portion having an outer peripheral surface in contact with an inner peripheral surface of the stator, a base portion extending radially outward from a lower portion of the tubular portion, and an outer wall extending downward from an outer portion of the base portion; a circuit board fixed to the stator holder; and a fastening screw with electrical conductivity including a head portion and a screw body, the fastening screw not only holding with the circuit board clamped between the head portion and the stator holder while the screw body is screwed to the stator holder, but also being in contact with both a frame ground portion of the circuit board and the stator holder.

The motor of the first configuration may be configured such that the circuit board includes an outer peripheral edge portion covered with the outer wall (second configuration).

The motor of the first or second configuration may be configured such that the stator holder further include a fastened portion provided integrally with at least one of the base portion and the outer wall to allow the screw body to be screwed into the fastened portion, and the circuit board is fixed to the stator holder using a fixing mechanism including the fastening screw and the fastened portion (third configuration).

The motor of any one of the first to third configurations may be configured such that the frame ground portion includes a first frame ground plane defined on a surface of the circuit board on a side opposing the base portion, and the first frame ground plane is in contact with the fastened portion (fourth configuration).

The motor of any one of the first to fourth configurations may be configured such that the frame ground portion further includes a second frame ground plane defined on a surface of the circuit board opposite to the surface on the side opposing the base portion, and the head portion includes a surface close to the screw body, the surface being a flat surface formed in a flat shape, the flat surface being in contact with the second frame ground plane (fifth configuration).

Any one of the motor of the third configuration, the motor of the fourth configuration including the third configuration, and the motor of the fifth configuration including the third configuration may further include a plurality of fixing mechanisms including at least a first fixing mechanism and a second fixing mechanism, the first fixing mechanism being provided counterclockwise from a power cable portion about the central axis as viewed in the axial direction, and the second fixing mechanism being provided clockwise side from the power cable portion about the central axis as viewed in the axial direction (sixth configuration).

The present disclosure is useful for a motor including a circuit board.

Features of the above-described example embodiments and the modifications thereof may be combined appropriately as long as no conflict arises.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A motor comprising:
a stator including coil portions arranged along a circumferential direction;
a rotor to cover a radially outer side of the stator and rotatable about a central axis extending in an axial direction;
a stator holder with electrical conductivity including a tubular portion including an outer peripheral surface in contact with an inner peripheral surface of the stator, a base portion extending radially outward from a lower portion of the tubular portion, and an outer wall extending downward from an outer portion of the base portion;
a circuit board fixed to the stator holder; and
a fastening screw with electrical conductivity including a head portion and a screw body, the fastening screw not only holding with the circuit board clamped between the head portion and the stator holder while the screw body is screwed to the stator holder, but also being in contact with both a frame ground portion of the circuit board and the stator holder.

2. The motor according to claim 1, wherein the circuit board includes an outer peripheral edge portion covered with the outer wall.

3. The motor according to claim 1, wherein
the stator holder further include a fastened portion provided integrally with at least one of the base portion and the outer wall to allow the screw body to be screwed into the fastened portion; and
the circuit board is fixed to the stator holder via a fixing mechanism including the fastening screw and the fastened portion.

4. The motor according to claim 3, wherein
the frame ground portion includes a first frame ground plane on a surface of the circuit board on a side opposing the base portion; and
the first frame ground plane is in contact with the fastened portion.

5. The motor according to claim 3, wherein
the frame ground portion further includes a second frame ground plane on a surface of the circuit board opposite to the surface on the side opposing the base portion;
the head portion includes a flat surface at or adjacent to the screw body; and
the flat surface is in contact with the second frame ground plane.

6. The motor according to claim 3, further comprising:
a plurality of fixing mechanisms including at least a first fixing mechanism and a second fixing mechanism;
the first fixing mechanism extending counterclockwise from a power cable portion about the central axis as viewed in the axial direction; and
the second fixing mechanism extending clockwise from the power cable portion about the central axis as viewed in the axial direction.
